(19) United States
(12) Patent Application Publication
(10) Pub. No.: US 2011/0246348 A1
(43) Pub. Date: Oct. 6, 2011

(54) Systems, Methods, and Apparatus for Creating and Trading Hybrid Derivative Financial Instruments

(75) Inventors: Robert Krause, Gillette, NJ (US); Donald Schlesinger, (US); Charles Barwis, New York, NY (US)

(73) Assignee: The VoIX Group Corporation, Gillette, NJ (US)

(21) Appl. No.: 12/983,851

(22) Filed: Jan. 3, 2011

Related U.S. Application Data
(60) Provisional application No. 61/319,297, filed on Mar. 31, 2010.

(51) Int. Cl. G06Q 40/00

(52) U.S. Cl. 705/37

(57) ABSTRACT

Computer systems, methods, and exchanges for generating and trading novel investment products (“Vxlshares”) are described. In some embodiments, the computer system comprises a computer-readable storage medium including data encoding a value for the Vxlshare based on an underlying. The computer-readable storage medium further includes data encoding an expiration date for the Vxlshare. The computer-readable storage medium of the computer further includes data encoding a price for trading the Vxlshare, the price for trading being a function of the underlying. The computer-readable storage medium also includes data encoding an alpha-numeric symbol for the Vxlshare. The computer is configured to enable execution of trades of the Vxlshare on a platform, such as options platform, an OTC platform, or a platform especially designed for the trading of Vxlshares, on which shares of fully collateralized instruments are traded.

### 1 CROSS-REFERENCE TO RELATED APPLICATIONS

This application claims priority under 35 U.S.C. §119(e) to provisional U.S. Patent Application Ser. No. 61/319,297 filed 31 Mar. 2010, the entire disclosure of which is incorporated herein by reference in its entirety and for all purposes.

### 2 BACKGROUND OF THE INVENTION

2.1 Field of the Invention

The present invention provides systems, apparatus, software, and methods for creating and trading unique investment instruments. The present invention thus has applications in the fields of finance and banking; the trading, pricing, and bidding of securities; and systems relating thereto.

2.2 The Related Art

Throughout the history of modern finance, portfolio managers and market practitioners have measured, calculated, dissected, analyzed, and attempted to manage risk. Investors today can choose from a myriad of investment types, each offering a particular combination of risk and return potential based on the particular terms of an investment contract, to create investment portfolios of almost arbitrarily complex risk-return characteristics. Generally, investment types fall into several broad categories: equity, futures, options, exchange-traded funds (“ETFs”), and, more recently, realized-volatility instruments, such as offered under the trademark VOLCONTRACT® by The Volatility Exchange Corporation (Gillette, N.J.). The benefits and limitations of each investment type are reviewed briefly below.

### 2.2.1 Equity

### 2.2.1.1 Generally

Equity is ownership in a public or private company, usually represented as “shares” which can be either public or private; publicly owned equity is almost always represented by tradable securities known as “stock” or “shares.” For the purposes of describing the present invention, only the relevant aspects of publicly traded shares, several important features of which are:
Typically, there are millions of shares outstanding.
Because ownership is divided into small pieces, individuals or entities can easily buy or sell small or large portions of the ownership of a company.
Shares can be freely traded on or off regulated exchanges.
Companies are perpetual and do not expire as a matter of design (of course, the company may cease to exist because of bankruptcy, merger, or some other corporate action).
Ownership is perpetual (again, shares do not expire as a matter of design).
Usually, the shares have voting rights and, as a consequence, owners ultimately have an effect upon the decisions of the company by voting for management.
Equity owners are usually the last to receive any of the profits of the company through either cash payments, called dividends, or retainment of those profits by the company, with the hope of a rising share price. For accepting the risk of being last to get paid, equity owners often enjoy the greatest rewards.
By convention, shares are typically traded in 100-share “blocks,” but shares also can be traded singly or in smaller groups.
Share prices are typically in the $10 to $100 per share range. Of course, the price may go outside of that range, but in that case a company often will invoke procedures such as stock splits or reverse splits in order to restore the shares' price range to $10 to $100 per share. Thus, in practice, share prices tend to have a “normalized” trading range of between about $10 and about $100.

### 2.2.1.2 Ownership

Unlike bonds, options, futures, and physical assets, stock represents ownership in a corporation; the corporation can be private (shares are restricted and not offered to the general public) or public (shares are easily traded and available to the public). Unlike futures, where there is a seller for every buyer (a short counterparty for every long), with stock, there are, in a manner of speaking, only buyers. The shares of the company are always owned by someone. Of course, an individual or company who owns the shares may sell (liquidate) them, but that does not imply the establishment of a short position in the company: it simply means that the ownership rights have been transferred to someone else.

In equity trading, it is possible to short a stock by finding someone who is willing to lend you his or her owned shares. The trader or investor then takes those borrowed shares and sells them, leaving the trader with no shares and an obligation to purchase them at a future date in order to return them to the original owner. This process allows the trader to sell stock that he does not own and buy it back at a later time, profiting if the share price falls over that period.

### 2.2.1.3 Uses of Equity

Many articles and academic studies have shown that equity ownership can be an integral part of a well-diversified portfolio. But the rewards of equity ownership come with risk. Other academic studies have advanced the topic of managing the risk of holding equity within investors' portfolios.

### 2.2.2 Futures

### 2.2.2.1 Generally

A futures contract is a legal agreement to buy or sell some underlying asset on a specific date in the future, called the “expiration date.” The futures contract is standardized to allow for easy transactions; it is traded on a regulated exchange that provides the means (execution), money movement and performance-bond requirement (clearing), compliance and surveillance (regulatory oversight), and education (marketing). Stating that a futures contract is a legal agreement implies that it is an obligation; once someone holds a futures contract, he or she must abide by its terms as required by law. There are only two ways to relieve oneself from this obligation: liquidate the contract prior to expiration, or allow the contract to expire and take delivery of the asset or receive a cash settlement if the contract is cash-settled. Nearly every major asset has a futures contract listed on it, as do hundreds of minor assets.

### 2.2.2.2 Futures Multipliers

Every futures contract has a multiplier; i.e., futures contracts are not available for single, or small, quantities of an asset, but rather for typical shipment sizes. For example, a standard futures contract on corn is for 5,000 bushels of corn (about one train-car load). Similarly, one can consider gold futures at 100-ounce increments, cattle futures at 38 head of cattle (about one train-car load), T-Bonds at $100,000 worth, etc.

### 2.2.2.3 Uses of Futures

Futures have two main purposes: to hedge (reduce risk by taking an equal and opposite position in the futures market for some previously existing risk in an asset), or to speculate (gain exposure to the asset's price movements in order to profit from a correct forecast).

### 2.2.3 Options

### 2.2.3.1 Generally

An options contract is a legal agreement giving the buyer the right, but not the obligation, to buy (in the case of a “call”) or sell (in the case of a “put”) some underlying asset at a specific price (the “strike price”) on a specific date (the “expiration date”) in the future. Unlike the buyer, the seller of the option has the obligation to perform. The options contract is standardized to facilitate transactions; it is traded on a regulated exchange that provides the means (execution), money movement and performance-bond requirement (clearing), compliance and surveillance (regulatory oversight), and education (marketing). Unlike a futures contract, an options contract confers to the buyer the right, but not the obligation, to purchase (in the case of a call), or sell (in the case of a put), the underlying. This simple idea of allowing the buyer the right to walk away from his potential obligation provides options traders with a unique opportunity and pricing that are not available in any other type of instrument. Nearly every major asset (stocks, ETFs, futures, OTC swaps, etc.) has a corresponding options market.

### 2.2.3.2 Option Multipliers

As for the case with futures, every exchange-traded options contract has a multiplier. For example, when the underlying asset is a stock, a typical options contract allows the buyer the right to buy or sell 100 shares of stock. If the underlying asset is a futures contract, the options are typically one option per futures; however, it must be remembered that, as described above, the underlying futures contract itself already has a multiplier.

### 2.2.3.3 Uses of Options

Uses of options can be broken down into two broad categories: (1) to hedge (reduce risk by taking an opposite position to some previous risk in an asset); and (2) to speculate (gain exposure in order to profit from a correct forecast).

### 2.2.4 Exchange-Traded Funds

One drawback to stocks is their inability to converge to any particular price that reflects the value of the assets underlying the stock. The financial world resolved that particular issue by creating exchange-traded funds (“ETFs”). An ETF is a security (i.e., a stock-like instrument) that tracks an underlying such as an index, a commodity, or a basket of assets, like an index fund; however, an ETF is traded like a stock on an exchange. Like stocks, ETFs experience price changes throughout the day as they are bought and sold, and their net asset values (“NAVs”) may or may not be calculated every day.

Prior to ETFs, funds called “closed-end funds” were structured as typical “companies” whose businesses were investments instead of products or services. The problem with a closed-end fund is the lack of any mechanism to force the price of the fund's shares to converge to the net asset value of the aggregate of the positions held within the fund. In essence the share price could trade at any value, like any other equity. The market generally avoided these funds, because there was no guarantee that one could anticipate the future direction of the underlying assets and be certain that the stock price reflected that reality. Most investors are reluctant to trade an instrument that does not reflect the “true” value of the positions within; thus, many closed-end funds trade at a discount.

ETFs solve the convergence problem by allowing significant holders of the shares to “exercise” or “convert” their shares to the basket of underlying instruments or securities (or both) that create the ETF's value, thereby addressing the issue of non-convergence by allowing shareholders to “pass through” and purchase the underlying assets in the fund if they so chose. Presumably, investors would exercise this privilege only when it was to their advantage to do so. So, if the share price is different from the price of the assets held in the fund, the investors could buy the shares and sell the underlying assets (or vice versa), thereby locking in a riskless profit. But typically, riskless arbitrage profit opportunities do not exist for long; therefore, this simple idea forces convergence and virtually guarantees that all investors will receive the value of the assets held within the company. Because there is a defined arbitrage opportunity, such variations in price are quickly removed from the market. This feature has proven successful because the ETF share price trades very near the NAV of the underlying assets held within the fund structure. The market seems to embrace that concept because of the huge volume that ETFs have enjoyed. However, because an ETF is, at its core, a fund of investments, the fund itself must invest in some underlying asset or instrument.

Thus, ETFs provide investors the diversification of an index fund as well as the ability to sell short, buy on margin, and purchase as little as one share. But ETFs also have drawbacks. The expense ratios for most ETFs are often higher than those of the average mutual fund: when buying and selling ETFs, traders incur the same brokerage commissions as with any regular order. Also, ETFs are expensive to establish and operate, requiring extensive overhead and management including fund managers, trustees, and their associated oversight. In addition, since ETFs are traded like any other equity, they also share the drawbacks of equity instruments noted above.

### 2.2.5 Realized Volatility

A more recent financial instrument has been developed that is based upon the realized volatility of some underlying. Examples of such instruments, called herein “realized volatility contracts” (or “RVCs”), are described and claimed in U.S. Pat. No. 7,328,184, which is incorporated herein by reference in its entirety and for all purposes, and are available under the trademark VOLCONTRACT™. As described in the '184 patent, the “last,” “close,” “final,” or “settlement” price of some underlying is determined each day over some predetermined period (e.g., one month); the prices at the close of each trading day during the period are applied to the realized-volatility formula, to calculate the inter-day realized volatility for the period. The instrument settles to this calculated value at the end of the period. Until the '184 patent, there was no blueprint for a direct, exchange-tradable, transparent way to hedge risk exposure from realized volatility.

The realized-volatility investment products that are the subject matter of the '184 patent have added a new dimension for traders to benefit from the markets. Participants have a new stock-like instrument (i.e., the VOLCONTRACT™ realized volatility contract) that allows them to speculate on, or hedge against, the price movement of an underlying asset or instrument as opposed to the price direction of that underlying asset or instrument. As the magnitude of movement of an asset is known as its “risk,” if a trader trades this movement, without regard to direction, the trader is, in effect, trading risk directly. For example, if the market moves up 1% or down 1%, it should make no difference to the ultimate price of a realized volatility contract because, either way, there is a 1% move. If a trader thinks the market will move a lot (become very volatile or unstable) compared to the current environment, he would buy (go long) a realized volatility contract; conversely, if a trader thinks the market will not move a lot (display low volatility, or stability) with respect to the current regime, he would sell (go short) a volatility contract. Profits would accrue if the price of the volatility contract moved in the desired direction, which is dependent on magnitude of the move of the underlying asset of the contract but is otherwise indifferent to the direction of that movement.

### 2.2.6 Current Investment Limitations

Despite their wide variety, the current state of financial instruments limits the potential for truly useful and innovative products. For example:
Currently, futures contracts have large notional values (typically, $25,000 to $100,000, and sometimes much more). This limits the potential market participants to only those with substantial capital.
Futures expirations typically occur every quarter for financial futures and often more frequently for commodities. Such fairly short time periods increase the costs to longer-term investors, as they must continually “roll” their position from one expiring contract to another in order to maintain a particular exposure over time.
A desirable feature of stocks is that longs pay in full and only short sellers are margined. In the futures market, both long and short holders are margined. The market is comfortable with buyers paying for the entire purchase of stock and not being able to lose more than their investment. Such defined risks are not available with futures that are margined.
Equities and futures contracts often trade on different execution platforms; this limits investors who are familiar with only one platform from investing in instruments that trade on another platform. Thus, investors familiar with futures cannot take full advantage of equities and vice versa.
Market participants that are equity traders are typically not the same as futures traders. This is because the typical use for equity is for “investment” while the typical use of futures is for “risk control.” While this is generally true, the lines between “investing,” “trading,” and “risk management” have been blurred, leading to increased desire for instruments that can function in both roles.
In the United States, futures are regulated by the Commodity Futures Trading Commission (“CFTC”), and the equity markets are regulated by the Securities and Exchange Commission (“SEC”). Many investors would like to have access to the opportunities afforded by futures, but through an execution platform meant to be regulated by the SEC or similar equity-side regulator.
ETFs can be costly because of an extra layer of fees imposed by the trustee and management company. Preferably, any new instrument would avoid large trustee fees and management fees.
ETFs have credit risk.
At its heart, an ETF is a fund. Funds must invest in some kind of asset or instrument, which adds risk to the fund and creates overhead, since the fund's underlying assets and instruments must be managed.

Thus, there remains a need to furnish investment instruments that provide still greater opportunities for managing risk and return. The present invention meets these and other needs.

### 3 SUMMARY OF EMBODIMENTS OF THE INVENTION

In one aspect, the preset invention provides a computer system for generating and trading a Vxlshare, which is defined below. In some embodiments, the computer system comprises a computer-readable storage medium including data encoding a value for the Vxlshare, which value is based on an underlying also as described below. The computer-readable storage medium further includes data encoding an expiration date for the Vxlshare. The computer-readable storage medium of the computer further includes data encoding a price for trading the Vxlshare, the price for trading being a function of the underlying such that the Vxlshare is priced in substantially the same units of the underlying or a fraction thereof. The computer-readable storage medium of the computer also includes data encoding an alpha-numeric symbol for the Vxlshare. The computer is configured to enable execution of trades of the Vxlshare on a platform on which shares of fully collateralized instruments are traded (e.g., a securities platform, an options platform, an OTC platform, or a platform especially designed for the trading of Vxlshares). However, the value for the Vxlshare is not based on the realized volatility of the underlying calculated according to a predetermined formula (Sᵥₒₗ), selected from the group consisting of:

$${S}_{vol} = \sqrt{\frac{P}{n - 1} {\sum }_{t = 1}^{n} {( {R}_{t} - \overline{R} )}^{2}} \qquad ( 1 )$$

wherein:
P=approximate number of trading periods in a calendar year, and each observation point “t” is taken at the same time in each trading period; and
R̅=mean of all Rₜ's;

$${S}_{vol} = \sqrt{\frac{{P}_{hl}}{n} {\sum }_{t = 1}^{n} {ln ( \frac{{h}_{t}}{{l}_{t}} )}^{2}} \qquad ( 2 )$$

wherein:
Pₕₗ=total number of trading periods in a year wherein two observations points “hₜ” and “lₜ” are used, and “hₜ” is the high price point and “lₜ” the low price point for each such trading period in that year; and
Rₜ=f{hₜ, lₜ}; and

$${S}_{vol} = \sqrt{\frac{{P}_{ohlc}}{n} {\sum }_{t = 1}^{n} [ \frac{1}{2} {ln ( \frac{{h}_{t}}{{l}_{t}} )}^{2} - ( 2 ln ( 2 ) - 1 ) ( ln \frac{{c}_{t}}{{o}_{t}} ) ]} \qquad ( 3 )$$

wherein:
P_{ohlc}=total number of trading periods, wherein four observations points “hₜ,” “lₜ,” “cₜ” and “oₜ” are used, and “hₜ” is the high price point, “lₜ” the low price point, “cₜ” is the closing, last or daily settlement price, and “oₜ” the opening price for each such trading period;
Rₜ=t{hₜ, lₜ, cₜ, oₜ}; and

$${S}_{vol} = \sqrt{\frac{P}{n} {\sum }_{t = 1}^{n} {R}_{t}^{2}} \qquad ( 4 )$$

wherein:
P=approximate number of trading periods in a calendar year, and each observation point “t” is taken at the same time in each trading period; and
n=total number of observations within the term; and
Rₜ=return of the underlying based upon each of the observation points in time “tₙ.”

In some embodiments, the expiration date is based on a related option expiration date. In more specific embodiments, the expiration date is daily, weekly, monthly, quarterly, or yearly. In other more specific embodiments, the expiration date is the last trading day of the year.

In other embodiments, the Vxlshare value is derived from the value of the underlying. In still other embodiments, the change in the value of the Vxlshare is inversely related to the change in the value of the underlying. In yet other embodiments, the change in the value of the Vxlshare is a multiple of the change in the value of the underlying. Still other embodiments include those in which the value is based on a local value of the underlying.

In another aspect, the computer system just described is coupled with an electronic platform (e.g., a securities platform, an options platform, an OTC platform, or a platform especially designed for the trading of Vxlshares). In more specific embodiments, the electronic platform includes the details described above. The provision of such systems can be accomplished by those having ordinary skill in the art using the present disclosure.

In still another aspect, the present invention provides methods for generating and trading a Vxlshare, comprising providing in a computer-readable storage medium computer-readable data encoding a value for the Vxlshare based on an underlying. The methods further comprise providing in computer-readable storage medium computer-readable data encoding an expiration date for the Vxlshare; providing in the computer-readable storage medium of the computer computer-readable data encoding a price for trading the Vxlshare; and providing in the computer-readable storage medium of the computer computer-readable data encoding an alpha-numeric symbol for the Vxlshare. However, the methods provided by the present invention do not include those wherein the value for the Vxlshare is based on the realized volatility of the underlying calculated according to a predetermined formula (Sᵥₒₗ), selected from the group consisting of:

$${S}_{vol} = \sqrt{\frac{P}{n - 1} {\sum }_{t = 1}^{n} {( {R}_{t} - \overline{R} )}^{2}} \qquad ( 5 )$$

wherein:

P=approximate number of trading periods in a calendar year, and each observation point “t” is taken at the same time in each trading period; and
R̅=mean of all Rₜ's;

$${S}_{vol} = \sqrt{\frac{{P}_{hl}}{n} {\sum }_{t = 1}^{n} {ln ( \frac{{h}_{t}}{{l}_{t}} )}^{2}} \qquad ( 6 )$$

wherein:
Pₕₗ=total number of trading periods in a year wherein two observations points “hₜ” and “lₜ” are used, and “hₜ” is the high price point and “lₜ” the low price point for each such trading period in that year; and
Rₜ=f{hₜ, lₜ}; and

$${S}_{vol} = \sqrt{\frac{{P}_{ohlc}}{n} {\sum }_{t = 1}^{n} [ \frac{1}{2} {ln ( \frac{{h}_{t}}{{l}_{t}} )}^{2} - ( 2 ln ( 2 ) - 1 ) ( ln \frac{{c}_{t}}{{o}_{t}} ) ]} \qquad ( 7 )$$

wherein:
P_{ohlc}=total number of trading periods, wherein four observations points “hₜ,” “lₜ,” “cₜ” and “oₜ” are used, and “hₜ” is the high price point, “lₜ” the low price point, “cₜ” is the closing, last or daily settlement price, and “oₜ” the opening price for each such trading period;
Rₜ=f{hₜ, lₜ, cₜ, oₜ}; and

$${S}_{vol} = \sqrt{\frac{P}{n} {\sum }_{t = 1}^{n} {R}_{t}^{2}} \qquad ( 8 )$$

wherein:
P=approximate number of trading periods in a calendar year, and each observation point “t” is taken at the same time in each trading period; and
n=total number of observations within the term; and
Rₜ=return of the underlying based upon each of the observation points in time “tₙ.”

In some embodiments, the expiration date is based on a related option expiration date. In more specific embodiments, the expiration date is daily, weekly, monthly, quarterly, or yearly. In other more specific embodiments, the expiration date is the last trading day of the year.

In other embodiments, the Vxlshare value is derived from the value of the underlying. In still other embodiments, the change in the value of the Vxlshare is inversely related to the change in the value of the underlying. In yet other embodiments, the change in the value of the Vxlshare is a multiple of the change in the value of the underlying. Still other embodiments include those in which the value is based on a local value of the underlying.

In still another aspect, the methods provided by the present invention include trading the Vxlshare using an electronic platform for trading Vxlshares.

Some embodiments of the present invention include purchasing the Vxlshare up front.

### 4 DETAILED DESCRIPTION OF SOME EMBODIMENTS OF THE INVENTION

### 4.1 Overview: Vxlshares Generally

The present invention provides novel stock-like, derivative investment instruments referred to herein generally as “Vxlshares.” As will be understood by those having ordinary skill in the art upon reading the disclosure herein, “Vxlshares” are hybrid investment instruments that incorporate, in a unique combination, features of stocks, futures, options, and, in some embodiments, volatility contracts, such as the volatility contracts offered under the trademark VOLCONTRACT™ by The Valuation Exchange Corporation (Gillette, N.J.). Vxlshares are exchange-tradable and off-exchange-tradable instruments that in certain aspects look, behave, and trade like stocks. Such hybrid instruments offer opportunities that traditional stocks, futures, and options cannot. For example, and without limitation, stocks represent ownership interest in a company, Vxlshares do not. Because of this, Vxlshares are more versatile than stocks by relieving the holder of the burdens of ownership. Vxlshares are defined by a value, a trading price, both such value and trading price being based on an underlying as defined hereinbelow, and an alpha-numeric trading symbol. Vxlshares can be executed on a platform on which shares of fully collateralized instruments are traded, or on any other suitable platform.

As used herein, an “underlying” is something from which a Vxlshare product derives its value. A suitable underlying can be any subject matter having a daily or intra-day price, including, but not limited to: a physical asset, instrument, basket, index, security, derivative, bond, debt, foreign currency, commodity, option, any measurement (such as snowfall, rainfall, temperature, carbon release or capture, emissions, heat, light, electricity, gas, liquid, solid, energy, air, water, etc.); any calculation of such subject matter (such as standard deviation, implied volatility, realized volatility, realized variance, correlation, dispersion, difference, ratio, regression, autocorrelation, etc.); and any other quantity that can be determined with sufficient robustness to define the terms of a Vxlshare instrument of the invention. Such quantities and their determination will be understood by those having ordinary skill in the art. In addition, the price and value of a Vxlshare instrument of the invention can be a quantity derived from the underlying itself, i.e., the “underlying” can be itself derived from the underlying as just defined. Moreover, the change in the price and value of the Vxlshare can be derived from the change in the price and value of the underlying. For example and without limitation, the change in the value of a Vxlshare can be a multiple of the change in the value of any of the above listed or unlisted underlyings, e.g., by applying a multiplier less than about ten (such as two, three, or five); or the change in the value of the Vxlshare can be inversely related to the change in the value of the underlying, for example by taking the negative of the change in the value of the underlying, and possibly even taking a multiple of that change value just described. Again, such determinations will be understood by those having ordinary skill in the art.

The disclosure herein may refer to share prices and other monetary amounts as part of the illustrative disclosure and examples used to describe the invention in U.S. currency as expressed in dollars (or by the abbreviations “$” and “USD”); however, such references to a particular currency are merely for the purpose of illustration and not limitation. As those having ordinary skill in the art will understand, the description of the invention can be adapted to any currency or system for defining price and value. The invention is in no way limited to any particular currency or system for expressing value and price.

In some embodiments, the primary characteristics of Vxlshares include, but are not limited to, a combination of the following (all examples are solely for purposes of illustration, not limitation):
Each Vxlshare represents one unit or “share” of the instrument, and has a share price that is substantially within a range of prices associated with equities (i.e., stocks). The identification and setting of such a share price will be familiar to those having ordinary skill in the art.
Block trading with a block size substantially similar to the sizes of blocks commonly used in equity trading, e.g., 100-share blocks. For example, if someone wanted to trade a certain stock, typically, he or she would buy 100 shares at a time. If the price of stock is $25 per share, and the trader buys 100 shares, then the total capital needed is $2,500 plus brokerage commissions. Similarly, if the Vxlshares were trading at $25 per share, and the traders executed a 100-share block, the buyer would need to pay $2,500. The identification and setting of a block size will be familiar to those having ordinary skill in the art.
Buyers purchase Vxlshares at full price; hence, the buyer cannot lose more than the initial investment. For example, in the example immediately above, the buyer pays $2,500 for 100 shares of stock. The stock price cannot fall below zero. And, since the buyer paid in full at the time of purchase, the buyer cannot lose more than his initial investment. Conversely, while there is a lower limit of zero, there is no upper limit. The stock could rise to $100 per share, $1,000 per share, and beyond. The details of setting share prices and executing purchases will be familiar to those having ordinary skill in the art.
Short sellers are margined in a manner similar to sellers shorting stock, and they can lose more than their initial investment. In some embodiments, if a trader desires to sell a stock short, he is margined according to a predefined formula. These details will be familiar to those having ordinary skill in the art. For example, suppose that a stock is sold short at $25 per share. Typically, the amount received (in this case, $2,500) plus 50% of the sale price ($12.50 per share or $1,250) needs to be posted as collateral in a margin account. Since the share price can fall to, at most, zero, the most that the short holder can make is $25 per share or $2,500. However, if the share price rose to, say, $37.50, the short holder would be out of capital; the broker would demand additional collateral or demand liquidation of the position. If the share price rose above $37.50, then the trader would have lost more than all of his initial capital. Similarly, Vxlshares has a margin requirement for short-sale positions.
Funds are not transferred daily (as is currently the case with futures, for example); buyers therefore will realize their gain or loss only after their position is liquidated. These details will be familiar to those having ordinary skill in the art. For example, in the futures markets both the buyer (long) and seller (short) are margined (to be even more accurate, in the futures industry, the term “margin” is not used: A concept similar to the posting of collateral is called a “performance bond”). For futures, daily movements in the instrument translate into actual funds flowing on a daily basis from buyer to seller, or vice versa. For Vxlshares the buyers pay in full; only short sellers are margined.
Buyers have a linear long exposure. These details will be familiar to those having ordinary skill in the art. For example, if the price of the Vxlshares is $50 per share and the price rises to $60 per share, then the buyer makes $10 per share. This is considered a linear exposure because for every $1 rise in price the buyer makes $1 in profit. By contrast options do not have a linear return. In the case of options, a $1 rise in price of the underlying asset normally causes a rise in price of less than $1 in a call option.
Sellers have a linear short exposure. These details will be familiar to those having ordinary skill in the art. For example, a stock price of $50 that rises to $60 causes a $10 loss for short sellers. This is considered a linear relationship because for every $1 gain in the price of the underlying, there is an equal $1 loss in the value of a short position, or vice versa.
Sellers wishing to gain short exposure do not have to borrow shares to do so. These details will be familiar to those having ordinary skill in the art. For example, to sell a stock short, one would need to find someone that owns the stock and borrow it from him or her; the borrower could then sell the stock in the market. When the borrower decided to liquidate the position, he would buy the stock back and return it to the original owner. In effect, this process allows someone to sell first and buy later, profiting from a price decline. In contrast, Vxlshares are not stocks and do not represent ownership in a company; this allows for an expansion or contraction in the number of shares based only on demand by buyers and sellers.
Market participants can short without restrictions. These details will be familiar to those having ordinary skill in the art. For example, the Securities and Exchange Commission has instituted the “Uptick Rule,” which specifies that a short seller cannot establish a short position until the stock rises at least one tick (an up tick); this was (supposedly) instituted to slow the market during market falls. However, since the Vxlshares instrument will be stock-like in many respects, it is not clear how the SEC or other foreign regulator would rule on various securities regulations, which also includes the Uptick Rule. Since Vxlshares are not stocks, there should be no such restrictions on initiating a short position.
Regulation of Vxlshares under rules for equities, as opposed to futures, i.e., regulation under the SEC in the U.S. and by a similar equity regulator in any non-U.S. country. These details will be familiar to those having ordinary skill in the art. Vxlshares are designed to look, behave, and trade like a share of stock; therefore, these instruments should be regulated as a security.
Vxlshares will expire. These details will be familiar to those having ordinary skill in the art. As will be understood by those having ordinary skill in the art, requiring expiration forces convergence. If the instrument expires to a known value, then market participants can arbitrage price discrepancies. If the price never converges, then there is no arbitrage, and therefore no way to bring the Vxlshares price in line with their intrinsic value. As will be further understood by those having ordinary skill in the art, ETFs differ from Vxlshares by forcing convergence through the feature of allowing the assets in the fund to pass through to the owners of the equity as explained above.
Vxlshares have an equity-like symbol that will allow them to trade on any electronic equity platform. These details will be familiar to those having ordinary skill in the art. There is a three- or four-character symbol for all publicly-traded equities in the U.S. There are similar shortened symbols for equities in other countries. Similarly, Vxlshares should have a symbol that identifies the product.
Vxlshares provide no ownership rights in the underlying. These details will be familiar to those having ordinary skill in the art. Vxlshares are derivatives. They do not represent ownership in a company. Because of this, they are more flexible than stocks. Removing the restriction of having to own something allows for the expiration price to be just about anything. For example, of course the shares could expire to the value of a stock. But, they do not have to. They could expire to the value of a formula, a measurement, or an index. Stocks cannot give market participants exposure to these items.
Settlement is into cash (for cash-settled Vxlshares) or into the underlying (for physically settled Vxlshares). These details will be familiar to those having ordinary skill in the art.
Where the underlying is based on volatility, the contract expiration can be on any day, for any length of time, and for any periodicity. In some embodiments, the expiration is based on an options expiration. In other embodiments, where the underlying is based on realized volatility, the expiration is based on monthly or quarterly Realized-Volatility Periods. In still other embodiments, listings occur for months in advance, quarters in advance, or a year or more in advance, as well. These details will be familiar to those having ordinary skill in the art. As described herein, it is possible for a Vxlshares to expire to a formula. In one specific type of Vxlshares such a formula could be the realized volatility of some underlying asset. The expiration date would probably be most useful as the one coinciding with the associated options expiration date. However, there may be a time or case where another expiration date is more desirable. Such conditions will be familiar to those having ordinary skill in the art.
Where the underlying is not based on volatility, the contract expiration can be on any day, for any length of time, and for any periodicity. In some embodiments, the expiration is based on a yearly periodicity. In other embodiments, the expiration is on the last trading day of the year (i.e., 31 December if that is the last trading day). These details will be familiar to those having ordinary skill in the art. In some embodiments, the expiration date is on the last day of the calendar year (31 December of each year) for Vxlshares that are not based on volatility. As will be recognized by those having ordinary skill in the art, yearly expirations provide a good balance between longer time periods (which would allow diminished ability to arbitrage the price to keep the Vxlshares close to it theoretical value), and the cost of having to “roll” positions from one contract to another several times a year (as is currently the case with quarterly futures contracts).
Expiration forces Vxlshares to “convert” to the underlying value or to “liquidate” to cash. These details will be familiar to those having ordinary skill in the art. As will also be understood by those having ordinary skill in the art, since expiration can be to a formula, value, measurement, or index, it behooves a trader to seriously consider (forecast) the expiration price when making an investment. Knowing that expiration will be to a defined value will help market participants to make better judgments as to the value of the current position and the potential returns that an investment into the instrument would exhibit.

In some embodiments, a Vxlshare includes at least a definition of the underlying, a price based on the underlying, an expiration date, an alpha-numeric symbol, and a share price that is a function of the underlying such that the share is priced in substantially the same units of said underlying or a fraction thereof. In more specific embodiments, the shares are traded on a platform on which shares of fully collateralized instruments are traded. These details will be familiar to those having ordinary skill in the art.

In some embodiments, the value (or the change in value) of the Vxlshares is based on the value (or change in value) of an underlying; in some embodiments, the value (or change in value) of the share is directly proportional to the value (or change in value) of the underlying; in other embodiments the value (or change thereof) is a fraction of the value (or change thereof) underlying; in still other embodiments, the value (or change in value) of the share is inversely proportional to the value (or change in value) of the underlying. In more specific embodiments, the degree of proportionality is less than about ten times the value (or change in value) of the value (or change in value) of the underlying. Examples of such embodiments include those instruments sold under the trademarks VALSHARE™, VELSHARE™, and VULSHARE™ by The Valuation Exchange Corporation (Gillette, N.J.). For example, in the case where the value is directly proportional, if the underlying were 20, then the share price is $20. In the fractional case, if the underlying were an index of large value, e.g., 10,000, the value of the share can be a fraction of the underlying to bring the value of the share to within a range more useful to investors, such as within the trading range of an equity (i.e., less than about $100). In this example, instead of setting the value of the share to $10,000, the share value could be defined to be, for example, 1/100 of the index (i.e., the underlying) such that the share price is $100 per share. As mentioned above, such a scaling of the underlying brings the value of the share into a range commonly found with equities, thereby, making the share more comfortable to investors accustomed to dealing with equity share prices in the $10 to $100 range. These details will be familiar to those having ordinary skill in the art.

In some embodiments, the value of the Vxlshares is based on the volatility of an underlying; in some embodiments, the volatility is the implied volatility; in other embodiments the volatility is the realized volatility. Examples of such embodiments include those instruments sold under the trademark VOLSHARE™ by The Valuation Exchange Corporation (Gillette, N.J.). As will be understood by those having ordinary skill in the art, there are two kinds of volatility: implied volatility and realized volatility. Both kinds of volatility can be determined using methods known to those having ordinary skill in the art. Examples of using realized volatility are provided in U.S. Pat. No. 7,328,184, the entire disclosure of which is incorporated herein by reference for all purposes. These details will be familiar to those having ordinary skill in the art.

In some embodiments, the value of the Vxlshares is based on the local market price (as opposed to a national or international price) of the underlying. Examples of such embodiments include those instruments sold under the trademark VILSHARE™ by The Valuation Exchange Corporation (Gillette, N.J.). These details will be familiar to those having ordinary skill in the art.

In a second aspect, the present invention provides computer systems configured to generate, trade, and settle Vxlshares contracts. The details of providing such systems will be familiar to those having ordinary skill in the art.

In a third aspect the present invention provides methods and systems for trading of Vxlshares. Such systems and methods include, in some embodiments, electronic networks of computers configured to assist in the generation, trading, and settlement of Vxlshares contracts. The details of providing such systems will be familiar to those having ordinary skill in the art.

In a fourth aspect, the present invention provides methods and systems for standardized trading of Vxlshares instruments.

### 4.2 Comparison with Traditional Investments

A helpful way to understand Vxlshares is to compare and contrast them with the various analogous instruments currently available in the marketplace. Those having ordinary skill in the art will thus better appreciate the uniqueness of Vxlshares.

### 4.2.1 Similar to Stocks

The share price will probably be similar to that of a stock (typically about $10 to $100), yet, it may trade outside that range.
Vxlshares probably will trade in 100-share blocks (but of course, like stock, any number of shares may be traded).
Buyers will pay the full price upfront; hence, they cannot lose more than their initial investment.
Short sellers will be margined similarly to shorting stock.
Buyers will have a linear long exposure.
Sellers will have a linear short exposure.
It is expected that Vxlshares will be regulated by the SEC in the U.S., or by a similar equity-side regulator in any non-U.S. country.
Vxlshares should have an equity-like symbol that will allow them to trade on any electronic trading platform.
The tax rules are expected to be the same as owning or shorting a share of stock (however, this is yet to be decided by the relevant taxing authority).

### 4.2.2 Dissimilar to Stocks

Sellers wishing to gain short exposure do not have to borrow shares to do so. Market participants should be able to short, without restrictions.
There are no ownership rights. Vxlshares can expire to cash (for cash-settled Vxlshares) or into the underlying (for physically settled Vxlshares).
Vxlshares have an expiration date.
The number of Vxlshares is not fixed, but depends on the market's demand, i.e., on the number of buyers and sellers of the Vxlshares in question. In contrast, absent certain rare events (e.g., issuing new shares or buying back existing shares), the number of shares of stock in a given company is a fixed number.

### 4.2.3 Similar to Futures

Vxlshares base their value on an underlying.
Exercise of “deliverable” Vxlshares is similar to the delivery mechanism of commodity futures (deliverable Vxlshares are those that convert into the underlying as opposed to “converting” to cash).
Exercise of “cash settled” Vxlshares is similar to cash-settled futures. In effect, allowing futures to expire is a way to liquidate the position.
Both Vxlshares and futures do not provide direct ownership.
Buyers will have a linear long exposure.
Sellers will have a linear short exposure.
Short positions will post margin.
Vxlshares have an expiration date.
Futures generally expire quarterly for financials. Vxlshares, in contrast, can expire at any time, and, in more particular embodiments, at the end of a calendar year for contracts not based on volatility, and monthly, quarterly, yearly, weekly, or daily for volatility-based contracts.

### 4.2.4 Dissimilar to Futures

May be displayed on a securities or options platform entirely different than such platforms for futures contracts ones that display securities transactions.
Long positions will not post margin (buyers pay in full).
Funds will not be transferred daily. Buyers will realize the gain or loss only after the position is liquidated.
Size of the instrument is relatively small (typical range of $10 to $100 per share) compared to most futures (typically in the range of $10,000 to $100,000 per contract, and sometimes much larger).
Trade in blocks like stocks (e.g., 100-lot blocks), whereas there is no typical size of a futures transaction.
Trade under SEC rules or similar foreign securities-type regulation.

### 4.2.5 Similar to ETFs

Mechanism exists to “convert” or liquidate to the underlying value.
Listed and quoted on electronic platforms designed for stock transactions.
Not a leveraged instrument (buyers will pay in full to be long).
Buyers cannot lose more than their initial investment.
Short sellers will be margined.
Size will be in similar amounts (typically within the $10 to $100 per share price range).
Normally priced in one-cent increments.
Blocks of typical equity size (e.g., 100-shares/block) available.
Buyers will have a linear long exposure.
Sellers will have a linear short exposure.
Trade under SEC rules in the U.S. or similar securities-side regulatory authorities in other countries.

### 4.2.6 Dissimilar to ETFs

Sellers with short exposure will not have to borrow shares.
Market participants will be able to short with no restrictions. ETF traders must borrow to short and may, at times, be prevented from borrowing. In addition, the ETF lender has the right to “buy in” the shares and require the borrower to return the borrowed shares, perhaps before the borrower's intent to do so.
Do not represent ownership.
Vxlshares will expire.
While both ETFs and Vxlshares converge, the methods of convergence are completely different; therefore, those having ordinary skill in the art will understand that Vxlshares and ETFs represent fundamentally different forms of investments. In the case of Vxlshares, convergence occurs because of expiration. ETFs converge because of a pass-through feature that allows the shareholder the right to buy the underlying assets held within the fund.
No fund needs to be created, and, therefore, there is no management fee.
No trustees are needed.
No fund positions need to be traded or managed, thereby saving execution costs.
The price of the instrument and the price of the underlying correspond, whereas the price of an ETF and the price of its underlying can be quite dissimilar (e.g., gold at $1,000 per ounce does not necessarily translate into an ETF at or near the $1,000 price). In contrast, Vxlshares can be traded in the same units as the underlying asset's price or a fraction thereof.

### 4.2.7 Similar to Options

Vxlshares base their value on an underlying.
Do not represent ownership.
Can be in one-cent price increments.
Buyers pay in full.
Short positions will post margin.
Security options trade under SEC rules in the U.S. or similar securities-side regulatory authorities in other countries.
Vxlshares based on volatility (e.g., the above-mentioned VOLSHARES™) could expire on any day, but options traders would find such shares particularly useful when the expiration day coincides with the expiration day of the options associated with the underlying.

### 4.2.8 Dissimilar to Options

Size of the instrument is relatively small (typical range of $10 to $100 per share) compared to most stock options that have a 100-share multiplier or to futures options, which are in the same notional size as the underlying futures contract.
Trade in 100-lot blocks; listed stock options trade in single units because they already represent 100-share lots (therefore, listed options cannot be broken down into single share increments).
Vxlshares buyers will have a linear long exposure, while option buyers have a convex exposure to the underlying.
Vxlshares sellers will have a linear short exposure, while option sellers have a concave exposure to the underlying.
There is no time premium.
There is no time decay.
There is no strike price.
There is no “call” or “put.”
There are no “Greeks” (δ, γ, θ, κ, ρ).
Options expire monthly. In contrast, Vxlshares can expire at any time, and, in some embodiments, e.g., those not based on volatility, expire on the last trading day of the year.

### 4.3 Execution and Trading Systems

In order to trade Vxlshares, there must be a mechanism for their execution. In one embodiment, the Vxlshares instruments are traded using open outcry on a trading floor. In another embodiment, the Vxlshares instruments are traded using an electronic platform. In a more specific embodiment, the present invention provides an electronic exchange comprising one or more computers in electronic communication. In a still more specific embodiment, the computers are configured to assist in generating Vxlshares contracts, matching buy and sell orders electronically using a predetermined method in which participants willing to buy (i.e., those “going long” or just “long”) are matched with those who are willing to sell (i.e., “going short” or just “short”), and executing trades. Such aspects of the invention are described in more detail below. Those having ordinary skill in the art will understand how to design and implement such systems using the disclosure herein.

Such a system provides for standardization of trading activities, allowing investors the advantages of investing with confidence in terms, conditions, and procedures that are afforded by an exchange, as opposed to the uncertainties of individual, non-standard trading practices. In still other embodiments, the exchange markets the investment products of the invention, and ensures that the participants are aware of specifications and other material aspects of the instrument. Those having ordinary skill in the art will understand how to design and implement such systems using the disclosure herein.

### 4.4 Clearing Transactions and Related Systems

In one embodiment, after an order is executed, transaction information is sent to an entity that ensures the following: that the trade was executed properly, that funds move if needed, and that all participants have the required collateral (called a performance bond) necessary to hold the position. Such activities can be incorporated into the above-described electronic trading system, as will be apparent to those having ordinary skill in the art. By way of illustration and not limitation, if the Vxlshares price moves against the buyer, no further action is required because the position is paid for in full and the holder cannot lose more than the initial investment; any gain would be realized at liquidation or expiration. If the Vxlshares price moves against the seller, the performance bond may be increased; the short seller may need to post additional collateral to maintain the position. The implementation of these and other details relevant to clearing trades will be understood by those having ordinary skill in the art.

In another embodiment of the above-described clearing mechanism, the clearing house does not deal with each trader directly, as described above, but instead deals only with intermediaries called “brokers,” who deal with the movement of funds through the clearing house. Such an arrangement makes trading a seamless and transparent process for the trader, who keeps an account with one or more brokers. This system guarantees that between every buyer and seller is a broker for each trader's account, and one clearing house between the brokers. The implementation of these and other details relevant to clearing trades will be understood by those having ordinary skill in the art.

### 4.5 Regulatory Regime

In some embodiments, the above-described activities are regulated by agencies responsible for the regulation of equities and options exchanges therefor. In the U.S., equity and equity options exchanges are regulated by the Securities and Exchange Commission (“SEC”); other countries have their own regulators to oversee the proper functioning of such exchanges. In other embodiments, at least some of the market oversight is delegated to one or more Self-Regulatory Organizations (“SROs”). The SRO is in charge of keeping the markets fair and orderly and to expel any member that materially violates any of the rules. Violation may result in loss of trading privileges; as soon as these are revoked, the trader may no longer participate in the industry on behalf of clients. If the violation rises to a criminal action, jurisdiction is moved to the appropriate authorities. In more specific embodiments involving an SRO, the exchange itself is an SROs for the products traded on the exchange. The implementation of these and other details relevant to clearing trades will be understood by those having ordinary skill in the art.

### 4.6 Variation

In alternative embodiments, the above-described requirement that the buyers of Vxlshares will pay the full amount for the purchase is relaxed using a margin requirement: buyers would need to post margin and possibly be required to post additional collateral to maintain a position in the event that the market price moved against them. Obligating the buyers to pay in full, or, alternatively, to pay only a portion of the total price, is within the scope of the invention. The implementation of these and other details relevant to clearing trades will be understood by those having ordinary skill in the art.

### 4.7 Computer Systems and Methods for Generating and Trading Vxlshares

In one aspect, the preset invention provides a computer system for generating and trading a Vxlshare. In some embodiments, the computer system comprises a computer-readable storage medium including data encoding a value for the Vxlshare, which value is based on an underlying as described above. The computer-readable storage medium further includes data encoding an expiration date for the Vxlshare. The computer-readable storage medium of the computer further includes data encoding a price for trading the Vxlshare, the price for trading being a function of the underlying such that the Vxlshare is priced in substantially the same units of the underlying, or a fraction thereof. The computer-readable storage medium of the computer also includes data encoding an alpha-numeric symbol for the Vxlshare. The computer is configured to enable execution of trades of the Vxlshare on a platform on which shares of fully collateralized instruments are traded. The determination of the foregoing values and their encoding into a computer system, and more particularly a computer-readable storage medium, will be familiar to those having ordinary skill in the art using the present disclosure.

However, the value for the Vxlshare is not based on the realized volatility of the underlying calculated according to a predetermined formula (Sᵥₒₗ), selected from the group consisting of:

$${S}_{vol} = \sqrt{\frac{P}{n - 1} {\sum }_{t = 1}^{n} {( {R}_{t} - \overline{R} )}^{2}} \qquad ( 9 )$$

wherein:
P=approximate number of trading periods in a calendar year, and each observation point “t” is taken at the same time in each trading period; and
R̅=mean of all Rₜ's;

$${S}_{vol} = \sqrt{\frac{{P}_{hl}}{n} {\sum }_{t = 1}^{n} {ln ( \frac{{h}_{t}}{{l}_{t}} )}^{2}} \qquad ( 10 )$$

wherein:
Pₕₗ=total number of trading periods in a year wherein two observations points “hₜ” and “lₜ” are used, and “hₜ” is the high price point and “lₜ” the low price point for each such trading period in that year; and
Rₜ=f{hₜ, lₜ}; and

$${S}_{vol} = \sqrt{\frac{{P}_{ohlc}}{n} {\sum }_{t = 1}^{n} [ \frac{1}{2} {ln ( \frac{{h}_{t}}{{l}_{t}} )}^{2} - ( 2 ln ( 2 ) - 1 ) ( ln \frac{{c}_{t}}{{o}_{t}} ) ]} \qquad ( 11 )$$

wherein:
P_{ohlc}=total number of trading periods, wherein four observations points “hₜ,” “lₜ,” “cₜ” and “oₜ” are used, and “hₜ” is the high price point, “lₜ” the low price point, “cₜ” is the closing, last or daily settlement price, and “oₜ” the opening price for each such trading period;
Rₜ=t{hₜ, lₜ, cₜ, oₜ}; and

$${S}_{vol} = \sqrt{\frac{P}{n} {\sum }_{t = 1}^{n} {R}_{t}^{2}} \qquad ( 12 )$$

wherein:
P=approximate number of trading periods in a calendar year, and each observation point “t” is taken at the same time in each trading period; and
n=total number of observations within the term; and

Rₜ=return of the underlying based upon each of the observation points in time “tₙ.”

In some embodiments, the expiration date is based on a related option expiration date. In more specific embodiments, the expiration date is daily, weekly, monthly, quarterly, or yearly. In other more specific embodiments, the expiration date is the last trading day of the year. These parameters can be determined by those having ordinary skill in the art using the present disclosure.

In other embodiments, the Vxlshare value is derived from the value of the underlying. In still other embodiments, the change in the value of the Vxlshare is inversely related to the change in the value of the underlying. In yet other embodiments, the change in the value of the Vxlshare is a multiple of the change in the value of the underlying. Still other embodiments include those in which the value is based on a local value of the underlying. These parameters can be determined by those having ordinary skill in the art using the present disclosure.

In another aspect, the computer system just described is coupled with an electronic platform for trading said Vxlshare. In more specific embodiments, the electronic trading platform includes the details described above. The provision of such systems can be accomplished by those having ordinary skill in the art using the present disclosure.

In still another aspect, the present invention provides methods for generating and trading a Vxlshare, comprising providing in a computer-readable storage medium computer-readable data encoding a value for the Vxlshare is based on an underlying. The methods further comprise providing in a computer-readable storage medium computer-readable data encoding an expiration date for the Vxlshare. The methods still further herein comprise providing in the computer-readable storage medium computer-readable data encoding a price for trading the Vxlshare; and providing in computer-readable storage medium computer-readable data encoding an alpha-numeric symbol for the Vxlshare. The foregoing can be accomplished by those having ordinary skill in the art using the present disclosure.

The foregoing methods provided by the present invention do not include those wherein the value for the Vxlshare is based on the realized volatility of the underlying calculated according to a predetermined formula (Sᵥₒₗ), selected from the group consisting of:

$${S}_{vol} = \sqrt{\frac{P}{n - 1} {\sum }_{t = 1}^{n} {( {R}_{t} - \overline{R} )}^{2}} \qquad ( 13 )$$

wherein:
P=approximate number of trading periods in a calendar year, and each observation point “t” is taken at the same time in each trading period; and
R̅=mean of all Rₜ's;

$${S}_{vol} = \sqrt{\frac{{P}_{hl}}{n} {\sum }_{t = 1}^{n} {ln ( \frac{{h}_{t}}{{l}_{t}} )}^{2}} \qquad ( 14 )$$

wherein:
Pₕₗ=total number of trading periods in a year wherein two observations points “hₜ” and “lₜ” are used, and “hₜ” is the high price point and “lₜ” the low price point for each such trading period in that year; and
Rₜ=f{hₜ, lₜ}; and

$${S}_{vol} = \sqrt{\frac{{P}_{ohlc}}{n} {\sum }_{t = 1}^{n} [ \frac{1}{2} {ln ( \frac{{h}_{t}}{{l}_{t}} )}^{2} - ( 2 ln ( 2 ) - 1 ) ( ln \frac{{c}_{t}}{{o}_{t}} ) ]} \qquad ( 15 )$$

wherein:
P_{ohlc}=total number of trading periods, wherein four observations points “hₜ,” “lₜ,” “cₜ” and “oₜ” are used, and “hₜ” is the high price point, “lₜ” the low price point, “cₜ” is the closing, last or daily settlement price, and “oₜ” the opening price for each such trading period;
Rₜ=f{hₜ, lₜ, cₜ, oₜ}; and

$${S}_{vol} = \sqrt{\frac{P}{n} {\sum }_{t = 1}^{n} {R}_{t}^{2}} \qquad ( 16 )$$

wherein:
P=approximate number of trading periods in a calendar year, and each observation point “t” is taken at the same time in each trading period; and
n=total number of observations within the term; and
Rₜ=return of the underlying based upon each of the observation points in time “tₙ.”

In some embodiments, the expiration date is based on a related option expiration date. In more specific embodiments, the expiration date is daily, weekly, monthly, quarterly, or yearly. In other more specific embodiments, the expiration date is the last trading day of the year. These parameters can be determined by those having ordinary skill in the art using the present disclosure.

In other embodiments, the Vxlshare value is derived from the value of the underlying. In still other embodiments, the change in the value of the Vxlshare is inversely related to the change in the value of the underlying. In yet other embodiments, the change in the value of the Vxlshare is a multiple of the change in the value of the underlying. Still other embodiments include those in which the value is based on a local value of the underlying. These parameters can be determined by those having ordinary skill in the art using the present disclosure.

In still another aspect, the methods provided by the present invention include displaying the Vxlshare using an electronic securities or options platform.

Some embodiments of the present invention include purchasing the Vxlshare up front.

### 4.8 Examples

Gold is trading at $1,000 per ounce. Suppose that it is the first trading day of 2011, and an exchange as described herein seeks to offer Vxlshares products in which the underlying is gold. Consider cases of two expirations: 2011 (which expire on 31 Dec. 2011) and 2012 (which expire on 31 Dec. 2012).

One Vxlshares product is that in which the value is directly proportional to the price of gold as first listed for trading; thus, as holding the Vxlshare is a surrogate for holding gold, the price will be similar to $1,000 per share. (Note, however, the correspondence may not be exactly 1:1, i.e., $1,000 per share, because physical gold needs to be stored and potentially insured. If these costs are not taken into account, then holding shares may have a cost advantage. In such cases, the price would typically adjust through arbitrage to a level where a market participant would be indifferent to buying gold or buying shares.)

Regarding the value of the shares, there is another consideration: The exchange may decide that a per-share price of roughly $1,000 is too high for the typical investor; so, it may divide the gold price by, say, 10 or 100 to get the share price to a level that would attract the most participants. Therefore, the exchange can also offer a second product priced at roughly $100 or $10 per share (i.e., one-tenth or one-one hundredth the price of gold), respectively.

Still another possible product is one that gives the buyer a leveraged way to invest in gold-based Vxlshares. Instead of a direct, one-for-one relationship with the price of gold, as VALSHARES™ products attempt to accomplish, these shares would be based on some multiple of the price of gold, e.g., two or three times the price of gold, such as traded using a VELSHARE™ product. Again, the expiration could be the last trading day of the year, expiring on the close of the last trading day of the year. The price could be discounted from the per-ounce price of gold in a way similar to that described above, but in this case the returns would be based on double or triple the returns of gold (both positive and negative).

Yet another product would be based on the inverse of the gold price, having the 2011 or 2012 expirations as above (e.g., using the above-described VULSHARE™ product). Thus, when gold price rises, the share price is expected to drop, and vice versa.

Consider a scenario using the three Vxlshares examples above, assuming that the gold price is $1,000 per ounce, and that there are no storage, insurance, or other costs associated with owning gold such that the share price for the case of a direct proportionality between the price of gold is 1/10 the price of gold (“Direct”). Also consider the performance of a product that priced at the original price of gold, plus or minus two times the change in the price of gold (expressed as a percent) (“Leveraged”). Finally, consider a product having an inverse relationship to the price of gold (“Inverse”). To make the example simpler, all Vxlshares products start trading at $100 per share. The following table summarizes the approximate prices one would see given the above assumptions (all values in USD).

| | Start | 1 Jul. 2011 | 31 Dec. 2011 | 31 Dec. 2012 |
|---|---|---|---|---|
| Gold | 1,000 | 1,100 | 900 | 1,500 |
| Direct | 100 | 110 | 90 | 150 |
| Leveraged | 100 | 120 | 80 | 200 |
| Inverse | 100 | 90 | 110 | 50 |

(Note: The prices the leverage and inverse products are approximate. The calculation depends on the exact returns each day instead of the returns from the “start” to the “end.” This could dramatically affect the leveraged or inverse values depending on the path taken to arrive at the observation point.)

The next example describes an innovative use of a Vxlshares product having value proportional to the underlying. Start with an equity index in a foreign country in a local currency; the goal is to trade the product on the index. However, instead of trading the share based in that local currency, base it in another currency, such as U.S. dollars. In effect, this design eliminates the currency risk from the equity index. Many portfolio managers are not versed in currency risks or do not have an expertise trading them. Hence, most portfolio managers trade the local security and then systematically hedge away the currency risk. This forces the manager to initiate at least two transactions.

If, instead, shares were listed using this local index as its underlying, but its value were based in U.S. dollars, the manager could gain the exposure to this foreign index without potentially losing any expected gain to an adverse currency move. The following table shows the potential of such a product.

| | Start | 1 Jul. 2011 | 31 Dec. 2011 | 31 Dec. 2012 |
|---|---|---|---|---|
| Foreign | 100 | 105 | 110 | 120 |
| Index | | | | |
| Exchange | 1.00 | 0.95 | 1.00 | 0.90 |
| Rate | | | | |
| Value | 100 | 105 | 110 | 120 |
| (Local) | | | | |
| Value | 100 | 99.75 | 110 | 108 |
| ($) | | | | |
| Vxlshare | 100 | 105 | 110 | 120 |
| Price | | | | |

As one can see, since Vxlshare are hybrid instruments and not stocks, they can base their value on the index in local currencies or in U.S. dollars or any other combination. In the above case, the shares are based on the Foreign Index exclusively and listed in U.S. dollars. This provides the same exposure as if the investment were devoid of currency risks (in this case, from a U.S. investor's perspective).

The final example describes Vxlshares based on realized volatility. In this case, traders are interested in trading realized volatility (as described in the above-incorporated '184 patent). Suppose that a rather contentious election is coming soon. The candidates have diametrically opposed platforms such that the financial markets are anticipating a huge rally if one candidate wins and a huge decline if the other candidate wins. However, the polls show that there is no clear favorite. In such a case, an investor would not know whether to buy or sell the underlying. Instead, what is “known” is the potential for a large move in either direction. In this case, the trader may want to buy volatility as opposed to direction. As long as the underlying makes a sufficiently large move, the buyer of shares should profit, especially when the large move happens within the realized-volatility period.

Unlike Vxlshares based directly on the price of an underlying (which are expected to expire the last trading day of the year or yearly), Vxlshares based on volatility would most likely correspond to monthly and quarterly realized-volatility periods as described in the '184 patent, and would expire monthly and quarterly, respectively. The exact expiration date would most likely occur on the associated options expiration date. The following table outlines three scenarios.

| | Start | Good Candidate | Bad Candidate | Postponed |
|---|---|---|---|---|
| Equity Index | 100 | 105 | 95 | 100 |
| Vxlshare Price | 20.00 | 23.24 | 23.24 | 15.49 |

The above table is just a hypothetical example. There are many factors that go into the pricing of volatility-based Vxlshares. The main point is that whether the underlying price makes a sufficiently large move up or down, the Vxlshare price should move up (all other factors remaining equal), or lose if the underlying remains unchanged. One may be curious as to why the shares would lose value if the market remained unchanged; this is because there is a certain amount of volatility expected and already priced into the instrument: If the market doesn't move as anticipated, then participants will probably lower their expectations of volatility.

### 5 CONCLUSION

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications.

What is claimed:

1. A computer system for trading a Vxlshare, comprising:
computer-readable storage medium of said computer including data encoding a value for said Vxlshare, said value being based on an underlying;
computer-readable storage medium of said computer including data encoding an expiration date for said Vxlshare;
computer-readable storage medium of said computer including data encoding a price for trading said Vxlshare, said price for trading being a function of said underlying such that said Vxlshare is priced in substantially the same units of said underlying or a fraction thereof;
computer-readable storage medium of said computer including data encoding an alpha-numeric symbol for said Vxlshare; and
said computer being configured to enable execution of trades of said Vxlshare on a platform on which shares of fully collateralized instruments are traded;
provided that said value for said Vxlshare is not based on the realized volatility of said underlying calculated according to a predetermined formula (Sᵥₒₗ), selected from the group consisting of:
$${S}_{vol} = \sqrt{\frac{P}{n - 1} {\sum }_{t = 1}^{n} {( {R}_{t} - \overline{R} )}^{2}} \qquad ( 17 )$$
wherein:
P=approximate number of trading periods in a calendar year, and each observation point “t” is taken at the same time in each trading period; and
R̅=mean of all Rₜ's;
$${S}_{vol} = \sqrt{\frac{{P}_{hl}}{n} {\sum }_{t = 1}^{n} {ln ( \frac{{h}_{t}}{{l}_{t}} )}^{2}} \qquad ( 18 )$$
wherein:
Pₕₗ=total number of trading periods in a year wherein two observations points “hₜ” and “lₜ” are used, and “hₜ” is the high price point and “lₜ” the low price point for each such trading period in that year; and
Rₜ=f{hₜ, lₜ}; and
$${S}_{vol} = \sqrt{\frac{{P}_{ohlc}}{n} {\sum }_{t = 1}^{n} [ \frac{1}{2} {ln ( \frac{{h}_{t}}{{l}_{t}} )}^{2} - ( 2 ln ( 2 ) - 1 ) ( ln \frac{{c}_{t}}{{o}_{t}} ) ]} \qquad ( 19 )$$
wherein:
P_{ohlc}=total number of trading periods, wherein four observations points “hₜ,” “lₜ,” “cₜ” and “oₜ” are used, and “hₜ” is the high price point, “lₜ” the low price point, “cₜ” is the closing, last or daily settlement price, and “oₜ” the opening price for each such trading period;
Rₜ=t{hₜ, lₜ, cₜ, oₜ}; and
$${S}_{vol} = \sqrt{\frac{P}{n} {\sum }_{t = 1}^{n} {R}_{t}^{2}} \qquad ( 20 )$$
wherein:
P=approximate number of trading periods in a calendar year, and each observation point “t” is taken at the same time in each trading period; and
n=total number of observations within the term; and
Rₜ=return of the underlying based upon each of the observation points in time “tₙ.”

2. The computer system of claim 1, wherein said expiration date is based on a related option expiration date.

3. The computer system of claim 1, wherein said expiration date is daily, weekly, monthly, quarterly, or yearly.

4. The computer system of claim 1, wherein said expiration date is the last trading day of the year.

5. The computer system of claim 1, wherein said value is derived from the value of said underlying.

6. The computer system of claim 5, wherein the change in said value is inversely related to the change in the value of said underlying.

7. The computer system of claim 5, wherein the change in said value is a multiple of the change in value of said underlying.

8. The computer system of claim 5, wherein said value is based on a local value of said underlying.

9. The computer system of claim 1, wherein said computer system is coupled with an electronic platform for trading said Vxlshare.

10. A method for trading a Vxlshare, comprising:
providing in computer-readable storage medium of said computer data encoding a value for said Vxlshare that is based on an underlying;
providing in computer-readable storage medium of said computer data encoding an expiration date for said Vxlshare;
providing in computer-readable storage medium of said computer data encoding a price for trading said Vxlshare; and
providing in computer-readable storage medium of said computer data encoding an alpha-numeric symbol for said Vxlshare;
provided that said value for said Vxlshare is not based on the realized volatility of said underlying calculated according to a predetermined formula (Sᵥₒₗ), selected from the group consisting of:
$${S}_{vol} = \sqrt{\frac{P}{n - 1} {\sum }_{t = 1}^{n} {( {R}_{t} - \overline{R} )}^{2}} \qquad ( 21 )$$
wherein:
P=approximate number of trading periods in a calendar year, and each observation point “t” is taken at the same time in each trading period; and
R̅=mean of all Rₜ's;
$${S}_{vol} = \sqrt{\frac{{P}_{hl}}{n} {\sum }_{t = 1}^{n} {ln ( \frac{{h}_{t}}{{l}_{t}} )}^{2}} \qquad ( 22 )$$
wherein:
Pₕₗ=total number of trading periods in a year wherein two observations points “hₜ” and “lₜ” are used, and “hₜ” is the high price point and “lₜ” the low price point for each such trading period in that year; and
Rₜ=f{hₜ, lₜ}; and
$${S}_{vol} = \sqrt{\frac{{P}_{ohlc}}{n} {\sum }_{t = 1}^{n} [ \frac{1}{2} {ln ( \frac{{h}_{t}}{{l}_{t}} )}^{2} - ( 2 ln ( 2 ) - 1 ) ( ln \frac{{c}_{t}}{{o}_{t}} ) ]} \qquad ( 23 )$$
wherein:
P_{ohlc}=total number of trading periods, wherein four observations points “hₜ,” “lₜ,” “cₜ” and “oₜ” are used, and “hₜ” is the high price point, “lₜ” the low price point, “cₜ” is the closing, last or daily settlement price, and “oₜ” the opening price for each such trading period;
Rₜ=t{hₜ, lₜ, cₜ, oₜ}; and
$${S}_{vol} = \sqrt{\frac{P}{n} {\sum }_{t = 1}^{n} {R}_{t}^{2}} \qquad ( 24 )$$
wherein:
P=approximate number of trading periods in a calendar year, and each observation point “t” is taken at the same time in each trading period; and
n=total number of observations within the term; and
Rₜ=return of the underlying based upon each of the observation points in time “tₙ.”

11. The method of claim 10, wherein said expiration date is based on a related option expiration date.

12. The method of claim 10, wherein said expiration date is daily, weekly, monthly, quarterly, or yearly.

13. The method of claim 10, wherein said expiration date is the last trading day of the year.

14. The method of claim 10, wherein said value is derived from the value of said underlying.

15. The method of claim 14, wherein the change in said value is a multiple of the change in the value of said underlying.

16. The method of claim 14, wherein the change in said value is inversely related to the change in the value of said underlying.

17. The method of claim 14, wherein said value is based on a local value of said underlying.

18. The method of claim 10, further comprising trading said Vxlshare using an electronic platform for trading Vxlshares.

19. The method of claim 10, further comprising purchasing said Vxlshare up front.

20. An electronic platform for trading Vxlshares, comprising a computer system of claim 1.
